(19) United States
(12) Patent Application Publication
(10) Pub. No.: US 2003/0047236 A1
(43) Pub. Date: Mar. 13, 2003

(54) Foaming device for beverage containers

(76) Inventor: Egon Ahlers, Hamburg (DE)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(21) Appl. No.: 10/130,970

(22) PCT Filed: Sep. 19, 2001
(86) PCT No.: PCT/EP01/10796

(30) Foreign Application Priority Data
Sep. 29, 2000 (DE) 100 48 761.0

(51) Int. Cl. B67C 3/00

(52) U.S. Cl. 141/144

(57) ABSTRACT

The invention relates to a foaming system for open beverage containers containing CO₂ and moving in a conveyor, said foaming system comprising a generator mounted in stationary manner on the conveyor to generate a short-term foaming impulsion applied to containers moving past, and it is characterized in that a suction device is mounted on the conveyor and near the rim of the mouth of the containers transported by said conveyor.

The present invention relates to a system defined in the preamble of claim 1.

Beverage container such as cans or bottles in general are filled in container-filling machines and then are moved to a sealing machine, hereafter capping machine, for sealing. On this transport, the containers are filled but not yet closed. The problem of air penetrating the container top volume above the liquid's level arises at all transport path segments along which filled but uncapped beverage containers are being moved. If subsequently the container shall be capped, then the penetrating air also will be enclosed in it. However the oxygen contained in said sealed-in air is damaging to most beverages. Therefore low quantities of air are desired in the capped container.

As regards beverages containing CO₂ in uncapped containers, foaming equipment is used which by means of a stationary means or apparatus induce the beverage of each container moving past it to foam by applying a foaming impulsion.

Said foam fills the top volume of the container and therefore no air may penetrate said container, and moreover any air that already did enter shall thereby be expelled. The above discussed air problem is therefore effectively solved in this manner.

In general the state of the art uses high-pressure water-jet nozzles as the means or apparatus for spraying a sharp jet of water for a brief time through the mouth of the container into the liquid within and to impart a foaming impulsion to said liquid. The foaming impulsion also may be generated in another way, for instance by tapping the container.

In general the means or apparatus for generating the foaming impulsion are adjustable and illustratively said impulsion may be varied by selecting a different length or a different impact of the spray jet of the foaming impulsion. As regards a typical container and typical operating times, said container top volume above the level of the beverage may be filled with foam until the container is capped, without said foam overflowing during this process.

However this operation is perfect only in the ideal case, even with continuous regulation. Any and each machine malfunction may entail overflowing foam. It is also known that the foam behaves very differently from one container to the next. If all containers of one series must be filled with foam up to the container rim, then foam overflowing must be expected for most of these containers.

On the other hand, overflowing foam is exceedingly disadvantageous. As regards the beverages, which mostly are sticky, for instance beer, overflow leads to glue deposits on the container, and hence subsequent cleaning will be required. As regards screw-cap bottles, the caps shall be glued shut and thereafter can only be removed with difficulty.

The objective of the present invention is to so further develop a foaming system of the above species that overflow of foam shall be effectively precluded in any container fully filled with foam in the volume above the beverage.

This goal is attained by the features of claim 1.

In the invention, a suction device is mounted on the conveyor and in the vicinity of the mouth rims of the containers, for instance bottles, arrayed there. The foam rising above the container rim is immediately evacuated by said suction device. The foaming impulsion may be selected to be ample enough to assure that foaming shall reliably take place in each container under all operating conditions. The foam overflow occurring in most containers is evacuated at once before it may drip down the container's outside or before entailing other soiling for instance on adjacent machinery. Even in the presence of tough, lengthy foaming, said suction can be applied with great reliability until foaming is finally over.

In the advantageous manner of claim 2, suction devices are mounted at each container site of a conveyor transporting individual containers and these suction devices move along with said containers. In this manner the foaming can be accompanied by suction until its end even over a relatively long conveying path.

The suction device may be fitted with a simple suction nozzle. Preferably however the features of claim 3 shall be used. This two-duct design makes it possible for instance to mount a simple shunt between the two suction nozzles and then to clean the circuit in the closed loop mode by means of the separate suction lines. In this manner the foaming system is made suited for Acleaning in place@ (CIP). As a result, the evacuated foam remains sterile and clean and can be used again. Illustratively it is known that for instance in larger breweries, yearly losses up to 1 million DM are incurred in the form of foam losses. These losses can be prevented by the present invention.

The system of the invention may be used with arbitrary conveyors, for instance conveying belts or the like. It also may be used with a revolving filling machine in an additional final stretch, after the filling procedure and before being moved to a further conveyor. This system furthermore may be used on a revolving capping machine in an initial stretch and before the time of capping. However the advantageous features of claim 4 may be exploited. Especially, a transfer star dedicated to the transfer purpose offers simples was to arrange the suction device at each container site.

The suction device defined in claim 5 is advantageously in the form of a stationary and elongated suction strip situated close to the mouths of the bottles moved on the conveyor. As a result the design of the suction hookups is much simplified.

The invention is elucidated in illustrative and schematic manner in the attached drawings.

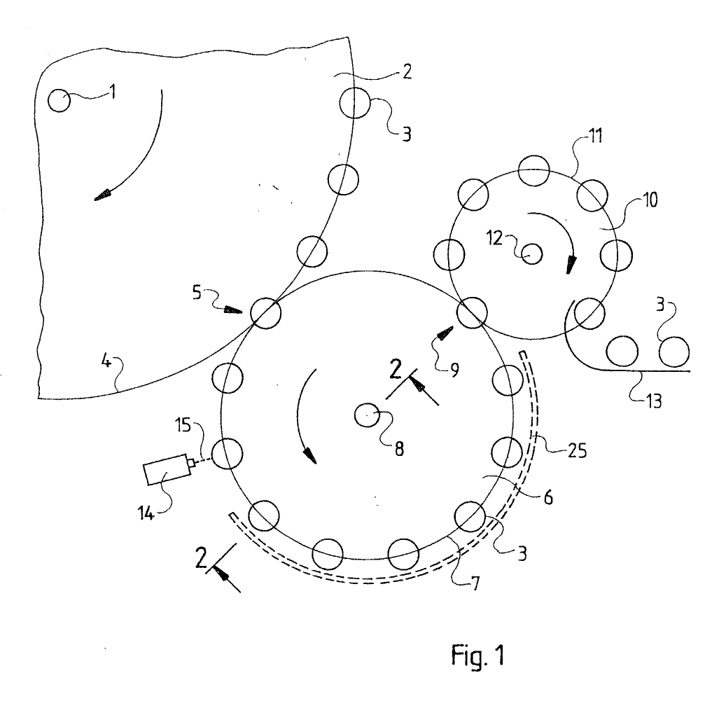

FIG. 1 is a schematic top view of a combined filling/sealing combination fitted with the transfer star of the invention,

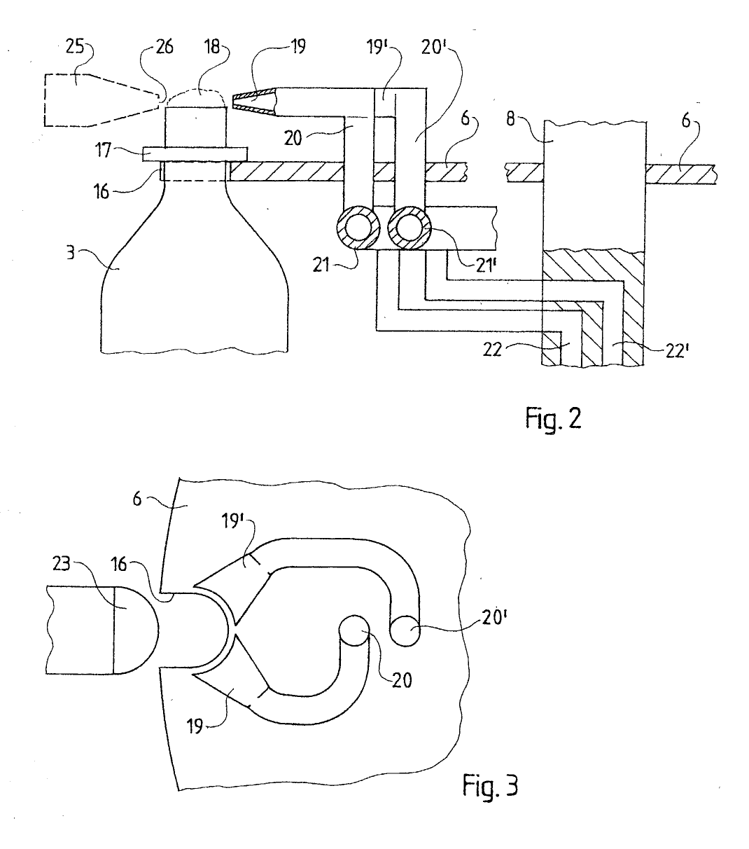

FIG. 2 is a section along line 2-2 of FIG. 1 of a container site of the transfer star, and

FIG. 3 is a top view of the container site shown in FIG. 2.

FIG. 1 is a top view of a beverage filling machine 2 which rotates about a shaft 1 in the indicated direction of rotation and which fills bottles 3 schematically indicated by their circumference and rotating together with said filling machine. The bottles 3 move along the circle 4 at container sites arrayed at constant circumferential spacings. Further details relating to a conventional beverage filling machine were omitted for the sake of clarity.

The bottles 3 are transferred at a transfer site 5 to a transfer star 6 on which they are kept on the circle 7 at omitted container sites and are moved around a shaft 8.

Next the bottles 3 are transferred from a transfer site 9 to a revolving capping machine 10 where they are held at circumferentially spaced container sites along a circle 11 while revolving about a shaft 12 and being sealed by omitted sealing means, whereupon they are transferred to a conveyor 13 not elucidated further herein.

A foaming impulsion generator 14 is mounted at a stationary site as near as possible to the transfer site 5.

In this embodiment said generator is a high-pressure water-jet injector which by means of a thin and sharp jet of high-pressure water 15 sprays water from above into the mouths of the bottles 3.

In the beverage filling machine 2, the bottles 3 are filled with a beverage containing CO₂, for instance beer. The foaming pulse produced by short injection of the high-pressure water jet 15 into the bottle 3, results in foaming of the beverage.

FIG. 2 is an axial section of the shaft 8 driven by omitted means and of the transfer star 6 shown simplified as a plate. This section runs through a container site which in this embodiment and as shown in comparison with the top view of FIG. 3, is in the form of a U-shaped seat 16. As shown by FIG. 2, this seat 16 exhibits a diameter matching the bottle neck and. by being placed underneath the conventional neck ring 17 of the bottle 3, is able to support latter.

FIG. 2 shows the state wherein the foam 18 just begins to rise above the mouth of the bottle 3. Assuming the bottle 3 were to move on, then the foam shall be expected continuing to rise and next run down the bottle 3 and soil it as well as at least the transfer star 6.

To prevent said eventuality, a suction device is present at the transfer star 6 at each container site, that is at every seat 16. The suction device comprises the suction nozzle 19 shown in FIGS. 2 and 3, and the nozzle is situated with their orifice in immediate vicinity of the rim of the mouth of the bottle 3. Even with slight suction of the suction nozzle 9, the foam 18 rising above the bottle rim is sucked off without losses.

As shown in FIG. 2, the suction nozzle 19 is connected by a line 20 to annular line 21 which is shown being connected to a borehole 22 in the shaft 8. This borehole 22 may be outwardly connected by a rotary joint to a suction means such as a vacuum pump. There the aspirated liquid may be recovered by omitted means and be returned into the filling procedure.

As shown in the top view of FIG. 3, the suction nozzle 19 is widened, in form of a slot, and made conforming to the rim circumference of the bottle 3 in order to attain especially effective and reliable suction.

In the preferred embodiment shown and as indicated by comparing FIGS. 2 and 3, two suction nozzles 19 and 19′ are configured in mutually symmetrical manner relative to the rim of the bottle 3. The second nozzle 19′ is connected through a line 20′ and an annular line 21′ to a second borehole 22′ in the shaft 8 which is also being connected rotatably and outward to a suction means.

By providing two separate suction nozzles 19 and 19′ each fitted with its own suction hookup elements, the sub-assembly of suction lines and the nozzles may be wholly cleansed in circulatory manner.

The cleaning operation merely requires moving the sealing inset 23 shown in FIG. 3 against the nozzles 19 ands 19′ to seal them thereby. The sealing inset 23 is fitted in manner not shown with an inside passage between the two suction nozzles. Accordingly the nozzles can be cleaned in circulatory manner through 22, 21, 20, 19 as well as through the sealing inset 23 and then further through 19′, 20′, 21′, 22′.

FIGS. 2 and 3 show a seat 16 cooperating with suction nozzles 19 and 19′. The same association takes place at all seats 16 of the transfer star 6, the nozzles 19 and 19′ each time being connected to the annular lines 21 and 21′.

Instead of operating with the shown two nozzles 19 and 19′, only one nozzle per seat 16 may be used, at the cost however of foregoing the above cited cleaning option.

In the above embodiment, the container sites at the transfer star 6 are in the form of the seat 16, namely for suspending bottles 3 fitted with neck rings. However said container sites also may be designed as conventional seats enclosing the body of the bottle 3 resting on a support, in which case the suction nozzles 19 and 19′ must be height adjustable to meet the conditions of different container heights. In an appropriate extension of the embodiment of the invention, excessive foam rises also may be prevented in beverage cans.

In the shown embodiment, foaming is indicated by means of the foam impulsion generator 14 and by means of the suction nozzles 19, 19′ at the transfer star 6. A corresponding device may also be alternatively employed at the container sites of the capping sub-assembly 10, namely, as seen in the direction of rotation, directly after the initial zone beyond the transfer site 9 before the containers shall be capped.

Especially effective, though slightly more difficult to design, would be to arrange the described foaming device on the filling machine 2 in a last sector, following the filling sector, immediately before the transfer site 5. This configuration offers the advantage of filling the transported containers in their top volume with foam as soon as possible.

Preferably and as shown in FIGS. 2 and 3, the one or several nozzles 19, 19′ which must be situated at a container site in the vicinity of the container rim shall be as close as possible to said rim. However and in illustrative manner, one central suction nozzle operating from above also might be used.

As regards the above described embodiment, the suction sub-assembly comprises suction nozzles 19, 19′ associated with each container site (seat 16) and moving along with it. In an alternative embodiment shown in dashed lines in FIGS. 1 and 2, however, a stationary suction sub-assembly also may be used.

Shown schematically, the stationary suction sub-assembly is a suction strip 25 enclosing the transfer star 6 at its circumference and near the rim of the bottle 3. Said suction strip 25 is fitted at its inside edge and over its full length with a suction slot 26 as indicated in FIG. 2. As shown in FIG. 1, the suction strip 25 as seen in the direction of advance begins immediately behind the foam impulsion generator 14 and it terminates shortly before the transfer site 9 to the capping machine 10. The suction strip 15 being stationary, it may be hooked up in a very simple way to an omitted suction source. Also it may be made suitable for Acleaning-in-place@ (CIP). For that purpose, for instance the suction slot 26 must be appropriately closed and the suction strip 25 for instance must be connected at the ends to suction lines communicating with a cleaning circuit. Moreover sub-division into two parts similar to the nozzles 19, 19′ is feasible, said two nozzles being sequential or superposed as desired.

Also the suction sub-assembly may assume the form of a plurality of suction nozzles arrayed in a row and mutually spaced from each other and enclosing the transfer star at its circumference near the bottle rims, the bottles transported by the transfer star moving past said nozzles.

1. A foaming system for open beverage containers (3) filled with a beverage containing CO₂ and moved in a conveyor (6), said system comprising a generator (14) arranged stationary at said conveyer and generating a short-term foaming impulsion into containers (3) moving by,
characterized in that a suction device (19, 19′, 25) is mounted on or near the conveyor (6) and is positioned near the rim of the mouth of the containers (3).

2. System as claimed in claim 1 for beverage containers (3) moved individually in container sites (16) of the conveyor (6),
characterized in that a suction device (19, 19′) moving together with the conveyor (6) is mounted at each container site (16) of the conveyor (6).

3. System as claimed in claim 1, characterized in that the suction device comprises two suction nozzles (19, 19′) connected to two separate suction lines (20, 20′).

4. System as claimed in claim 1, characterized in that the suction device (19, 19′, 25) is mounted on or near the transfer star (6) between a contained filling machine (2) and a capping machine (10).

5. System as claimed in claim 1, characterized in that the suction device is designed as a stationary, elongated suction strip (25) situated besides the conveyor (6) and near the rim of the mouth of the containers (3) transported by this conveyor.
